(19) United States
(12) Patent Application Publication
(10) Pub. No.: US 2004/0027311 A1
(43) Pub. Date: Feb. 12, 2004

(54) Display apparatus

(75) Inventor: John Robert Hunt, Lisburn (IE)

Correspondence Address: BAKER BOTTS L.L.P., 30 Rockefeller Plaza, New York, NY, 10012-4498, US

(73) Assignee: MARKETING WORKS INTERNATIONAL LIMITED.

(21) Appl. No.: 10/428,380

(22) Filed: May 2, 2003

Related U.S. Application Data
(63) Continuation of application No. PCT/EP01/12914, filed on Nov. 5, 2001.

(30) Foreign Application Priority Data
Nov. 3, 2000 (GB) GB 0026909.2
May 10, 2002 (WO) 02/37459

(51) Int. Cl. G09G 5/00

(52) U.S. Cl. 345/4

(57) ABSTRACT

A display apparatus is disclosed for displaying at least one orientation-sensitive image on an image sheet, when the viewer is at a required orientation relative to the image sheet, wherein the display apparatus has a base member; a support member for carrying at least one lenticular image, the support member being pivotably coupled to the base member, and means for angularly displacing the support member relative to the base member.

This application is a continuation of international PCT application Serial No. PCT/EP01/12914, filed Nov. 5, 2001and published as WO 02/37459 on May 10, 2002 in English, which claims priority to Great Britain application Serial No. GB 0026909.2 filed Nov. 3, 2000.

### BACKGROUND OF THE INVENTION

The present invention relates to a display apparatus for displaying at least one image on an image sheet, when a viewer is at a required orientation relative to the image sheet.

One such image sheet is a lenticular image which allows a viewer to view two or more different images, the image viewed depending on the angle (or orientation) at which the viewer observes the lenticular. image. The lenticular image comprises a plurality of parallelly disposed elongate lenses placed over interleaved slices of the images to be viewed. The device can be used to show entirely different images or can be used to generate an impression of motion.

Another such image sheet is a hologram whose image appears when viewed at the correct angle of light. A hologram is a three-dimensional image produced by an interference pattern of laser light. A “master” holographic image is produced by directing a laser beam through an array of high precision optical instruments onto the subject and then recording the direct and reflected light onto a photosensitive plate. Alternatively, computers can be used to process the image(s). The master image is then electroplated onto a nickel “shim” which is then used for embossing the required quantities onto thin plastic film or metallized foil. These substrates are then coated with laminates and/or adhesives.

Another such image sheet is a data-embedded plastic sheet which can display a three-dimensional image, a movie sequence or a plurality of individual images in sequence. The viewing surface of the image sheet has hundreds of tiny ridges which function as lenses or lenticules. One example of a data-embedded sheet is sold under “3-D Plus”, a registered Trade Mark of Citadel Ventures, Singapore.

All such image sheets are encompassed by the term “orientation-sensitive images” which is defined as any image, for which viewing of at least one image therefrom depends on the orientation of the viewer relative to the image.

It is well known for such orientation-sensitive images to be used in the field of advertising. Typically, an orientation-sensitive image is mounted on a wall or similar surface so that, as the viewer travels past the image, he first views at least the one image. There is a problem, however, in that the viewer is required to travel past the orientation-sensitive image in order to view the image or the different images available. Moreover, reliance is placed on the viewer continuing to look at the device as he travels past—otherwise the image, or not all of the available images, are viewed. Further, if a viewer views the device head on, then he may only observe an indistinct jumble of images.

In view of these problems, and since they are relatively expensive to produce, orientation-sensitive images normally have a limited appeal to businesses such as advertisers.

It is an object of the present invention to mitigate the problems associated with the prior art.

### SUMMARY OF THE INVENTION

Accordingly, the present invention provides an orientation-sensitive image display apparatus comprising a base member; a support member for carrying an orientation-sensitive image, the support member being coupled to the base member; and means for angularly displacing the support member relative to the base member.

The term “angular displacement” is intended to embrace both pivotable and arcuate displacement of the support member relative to the base member. Arcuate displacement (movement in an arc) is preferred.

Preferably, the support member is pivotably movable, via a pivot axis, with respect to the base member.

Preferably, the orientation-sensitive image includes a plurality of lenses, the orientation-sensitive image being carried on the support member so that the lenses are substantially parallelly disposed with respect of the pivot axis of the support member.

More preferably, the base member is mounted, in use, on a surface so that the lenses of the orientation-sensitive image are substantially horizontally disposed.

Preferably, the displacing means is arranged to displace the support member between a plurality of angularly displaced display states.

More preferably, the displacing means includes means for maintaining the support member in each display state for a pre-determined period of time.

Preferably, the displacing means includes means for adjusting the angular displacement between adjacent display states.

Preferably, the displacing means includes means for adjusting the angular position of the support member in a display state with respect to the base member.

Preferably, the displacing means comprises an actuator coupled to a lever member on one side thereof and adapted to effect, in use, reciprocating motion of the opposed side of the lever member, the opposed side of the lever member being coupled to the support member such as to effect reciprocating motion thereof. Preferably, the lever member is coupled to the support member by means of a belt and pulley system. Preferably, the actuator comprise a hydraulic/pneumatic ram. Alternatively, the actuator comprises a motor and cam assembly.

Alternatively, the displacing means comprises a motor and crank assembly coupled between the base member and the support member, the crank assembly comprising a rotatable member coupled to the motor shaft for rotation therewith and a lever member coupled to the rotatable member. Preferably, the angular position adjustment means comprises a plurality of first coupling members spaced-apart along the longitudinal axis of the lever member, and at least one co-operating coupling member provided on the rotatable member for coupling to a selected one of said first coupling members. Preferably, the angular displacement adjustment means comprises a plurality of radially spaced-apart second coupling members provided on the rotatable member, and at least one co-operating coupling member provided in the lever member for coupling to a selected one of said second coupling members. Preferably, the display state maintaining means comprises a slide assembly provided on the lever member, the slide assembly comprising a male member slidably received in an elongate female member, the arrangement being such that rotation of the rotatable member causes the male member to slide along the female member and pivotable movement of the support member is effected when the male member engages with either end of the female member. Preferably, the rotary motor is provided on the base member and the lever member is coupled to the support member.

### BRIEF DESCRIPTION OF THE DRAWINGS

Embodiments of the invention will now be described by way of example and with reference to the accompanying drawings in which:

FIG. 1 is a schematic view of an orientation-sensitive image;

FIG. 2 is a perspective view of a first embodiment of an orientation-sensitive image display apparatus according to the invention;

FIG. 3 is a side view of the orientation-sensitive image display apparatus of FIG. 2;

FIG. 4 is a schematic perspective view of a second embodiment of an orientation-sensitive image display device according to the invention;

FIG. 5 is a schematic side view of the apparatus of FIG. 4;

FIGS. 6a and 6b are further schematic side views. of the apparatus of FIG. 4;

FIG. 7 is a perspective view of a third embodiment of an orientation-sensitive image display apparatus according to the invention;

FIG. 8 is a perspective view of the pivoting means of the orientation-sensitive image display apparatus of FIG. 7;

FIG. 9 is a side view of the orientation-sensitive image display apparatus of FIG. 7;

FIG. 10 is a schematic side view of the apparatus of FIG. 7;

FIG. 11 is a perspective view of the apparatus of FIG. 7 mounted to a table top or similar substantially horizontal surface;

FIGS. 12a and 12b are further schematic side views of the apparatus of FIG. 7;

FIG. 13 is a perspective view of a fourth embodiment of the invention;

FIG. 14 is a side view of the embodiment of FIG. 13;

FIG. 15 is a cross-sectional side view of the lens housing of the embodiment of FIG. 13;

FIGS. 16 and 17 are side views of a fifth embodiment of the invention;

FIG. 18 is a plan view of the base frame of the embodiment of FIG. 16;

FIG. 19 is a plan view of the base frame of FIG. 18, showing its contents in hidden detail;

FIG. 20 is a rear view of the base frame of FIG. 18; and

FIGS. 21 and 22 are views of a sixth embodiment of the invention.

### DETAILED DESCRIPTION OF THE PREFERRED EMBODIMENTS

The following description confines itself to lenticular images. The skilled reader will appreciate that the invention is not so limited but also embraces all other orientation-sensitive images, as hereinabove defined.

In the drawings, similar numerals have been given to like parts.

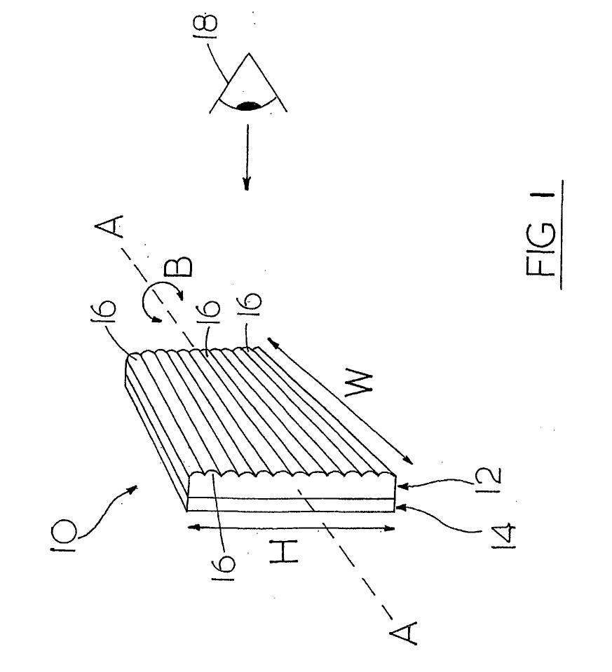

Referring now to FIG. 1 of the drawings, there is shown a lenticular image, generally indicated at 10. The lenticular image 10 comprises a sheet 12 of lenticular material and an image substrate 14. The lenticular sheet 12 comprises a plurality of parallelly disposed lenses 16 each having their respective axis of curvature parallel with their longitudinal axis.

The image substrate 14, which may for example be paper, carries interleaved image slices (not shown). Each image slice comprises a portion of a whole image and the image slices of one whole image are interleaved with the image slices of another whole image on the substrate 14. The image slices are aligned with the lenses 16 so that a viewer (whose eye is indicated schematically at 18) sees a particular set of image slices (and therefore a particular whole image) depending on the angle at which he views the lenticular image 10. The image slices may alternatively be printed directly on the reverse face (not visible) of the sheet 12 in conventional manner.

It will be apparent that the whole images carried on the substrate 14 can be viewed sequentially upon relative angular (includes pivotable or rotational, as well as, arcuate) movement between the viewer 18 and the lenticular image 10. The images viewed may be entirely different or may be incremental versions of the same image to give an impression of motion. Typically, the image substrate 14 carries two interleaved images but may equally carry more than two.

The curvature of the lenses 16 is determined in conventional manner to suit the number and nature of the images to be displayed.

In the lenticular image of FIG. 1, the interleaved images on the substrate 14 are substantially perpendicularly disposed with respect to the longitudinal axis of the lenses 16. The viewer 18 can thus view the different images upon angular displacement (rotation or pivoting, as well as arcuate) of the lenticular image 10 about an axis A-A as indicated by the arrow B. The axis A-A runs substantially parallel with the longitudinal axis of the lenses 16. The axis A-A may, in use, be mounted in either a substantially vertical or horizontal plane, but in the preferred embodiment is mounted in a substantially horizontal plane. If the axis A-A is substantially co-planar with the lenticular image 10, the angular displacement effects rotation or pivoting of the lenticular image 10. However, if the axis A-A is located in a plane which is substantially parallel with, but spaced apart from, the plane of the lenticular image (not shown), the angular displacement effects arcuate movement of the lenticular image 10. This applies to all embodiments of the apparatus of the present invention.

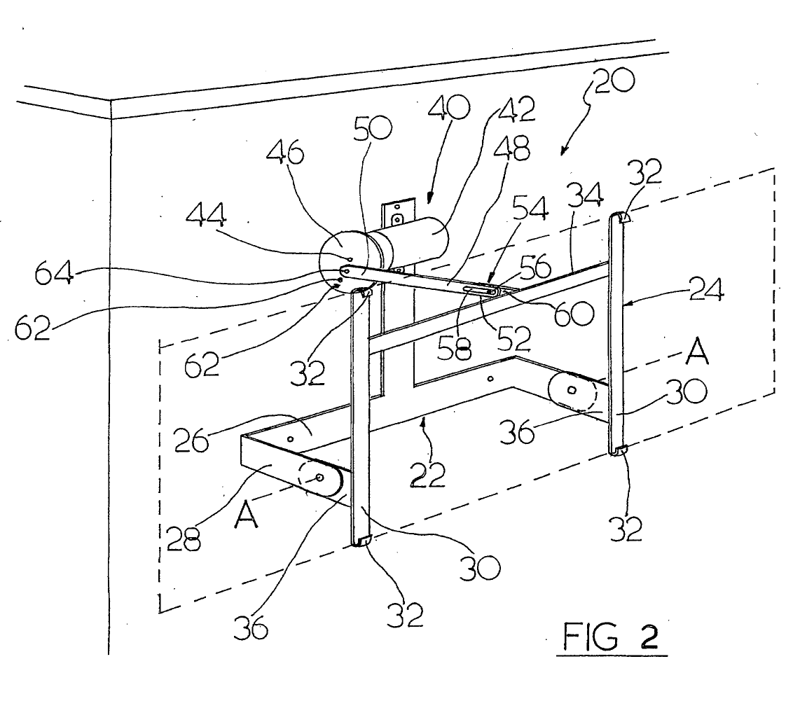

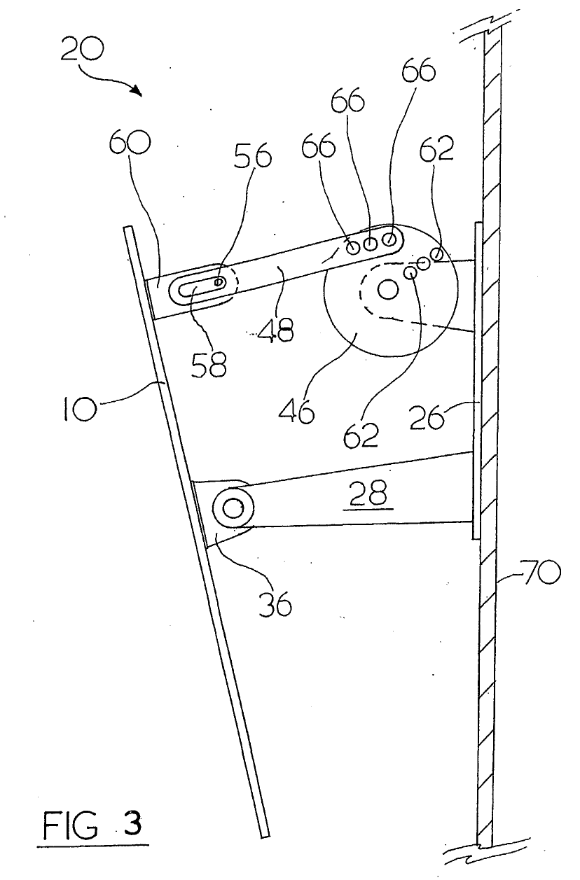

Referring now to FIGS. 2 and 3, there is shown a lenticular image display apparatus, generally indicated at 20. The apparatus 20 comprises a base member, or base frame 22, and a support member, or support frame 24.

The base frame 22 comprises a inverted “T”-shaped backplate 26 and a pair of mutually spaced-apart arms 28 projecting substantially perpendicularly therefrom.

The support frame 24 comprises a pair of spaced-apart retaining members 30 having hooked or U-shaped ends 32. A cross piece 34 is connected between the retaining members 30 to provide support. Each retaining member 30 has a respective lug 36 projecting rearwardly and perpendicularly from the common plane of the retaining members 30 and the cross piece 34.

The lugs 36 are pivotably connected to a respective arm 28 in conventional manner so that the support frame 24 is pivotable with respect of the base frame 22 thereby defining a pivot axis A-A.

Pivoting means in the form of a motor and crank assembly, generally indicated at 40, are provided between the base frame 22 and the support frame 24. The assembly 40 comprises a rotary motor 42 having a drive shaft 44; a rotatable member or disc 46; and a lever member or lever 48. The motor 42 is, for example, a conventional electric motor which preferably runs at between 1 rpm and 8 rpm.

The disc 46 is connected to the drive shaft 44 for rotation therewith and the lever 48 has one end 50 connected to the disc 46. The motor 42 is fixed to the backplate 26 of the base frame 22 and the other end 52 of the lever 48 is coupled to the cross piece 34 of the support frame 24. Equally, the motor 42 may be mounted on the support frame 24 and the lever 48 coupled to the base frame 22.

When the motor 42 is operated, the lever 48 translates rotational movement of the disc 46 into angular movement of the support frame 24 about the pivot axis A-A relative to the base frame 22.

It will be apparent that the motor and crank assembly 40 actuates the support frame 24 between two angularly displaced extreme positions which are determined by the effective length of the lever 48 and the radial distance between its end 50 and the drive shaft 44. The apparatus 20 is configured so that these positions serve as angularly displaced display states for displaying the whole images carried by the lenticular image 10.

The pivoting means includes means for maintaining the support frame 24 in each such display state for a pre-determined period of time. To this end, a slide assembly 54 is provided at an other end 52 of the lever 48. The slide assembly 54 includes a male member in the form of a pin 56; and a co-operating female member in the form of an elongate slot 58. The pin 56 is carried by a mounting bar 60 which projects rearwardly from the cross piece 34. The arrangement is such that the pin 56 is substantially parallel with the cross piece 34. The slot 58 is formed in the lever 48 adjacent the end 52. The pin 56 is slidably received in the slot 58—the slide assembly 54 thus provides the coupling between the lever 48 and the support frame 24.

As the disc 46 rotates and actuates the lever 48, the pin 56 slides along the slot 58. It will be apparent that the pivotable movement of the support frame 24 is only effected when the pin 56 engages with one or other ends of the slot 58. Thus, while the pin 56 is moving between ends, the support frame 24 is maintained within one or other of the display states. The length of time for which the display states are maintained depends on the dimensions of the slot 58 and the speed of the motor 42.

The pivoting means further includes means for adjusting the extent of angular displacement between adjacent display states. The angular displacement adjustment means comprises a plurality of radially spaced-apart first coupling members 62 provided on the disc 46; and a co-operating coupling member 64 provided in the lever 48 for connection with a selected one of the first coupling members 62. In the embodiment of FIGS. 2 and 3, three first coupling members 62 are provided in the form of coupling pins 62. The co-operating coupling member 64 takes the form of a pin-receiving aperture 64 located adjacent the end 50 of the lever 48. It will be apparent that the radius of the orbit of the end 50 depends on to which coupling pin 62 it is coupled. Clearly, the radius of the orbit determines the angular displacement between display states.

The pivoting means also includes means for adjusting the angular position of the support frame 24 with respect to the base frame 22. The angular position adjustment means comprises a plurality of second coupling members 66 (not shown in FIG. 2) spaced-apart along the longitudinal axis of the lever 48; and a co-operating first coupling member 62 provided on the disc 46. In the embodiment of FIG. 3, three second coupling members in the form of pin-receiving apertures 66 are provided on the lever 48 and the co-operating first coupling member 62 is provided by one or other of the coupling pins 62. Clearly the pin-receiving aperture 66 can also serve as the pin-receiving aperture 64. The effective length of the lever 48, and therefore the throw of the lever 48, is determined by which pin-receiving aperture 66 is coupled to the coupling pin 62. Thus, the angular position of the support frame 24 with respect to the base frame 22, and therefore the angular position of the display states, can be adjusted.

In use, the apparatus 20 is mounted on a substantially vertical surface such as a wall 70 and arranged such that the pivot axis A-A of the support frame 24 is substantially horizontally disposed. A lenticular image 10 (indicated in dashed outline in FIG. 2) is mounted on the support frame 24 and is retained in position by the U-shaped ends 32 of the retaining members 30. The lenticular image 10 is of the type described with reference to FIG. 1 in which the lenses 16 run substantially perpendicularly to the interleaved images. The lenticular image 10 is mounted on the support frame 24 so that the lenses 16 are substantially horizontally disposed i.e. their respective longitudinal axis, and therefore their respective axis of curvature, are substantially horizontally disposed and substantially parallel with the pivot axis A-A of the apparatus 20.

An operator (not shown) adjusts the position of the display states and the angular displacement between display states as outlined above to suit the particular lenticular image 10 being used. While the motor 42 is operated, the lenticular image 10 is angularly displaced, back and forth between display states and is maintained in each-display state for a pre-determined period of time as determined by the slide assembly 54 and the motor 42 speed.

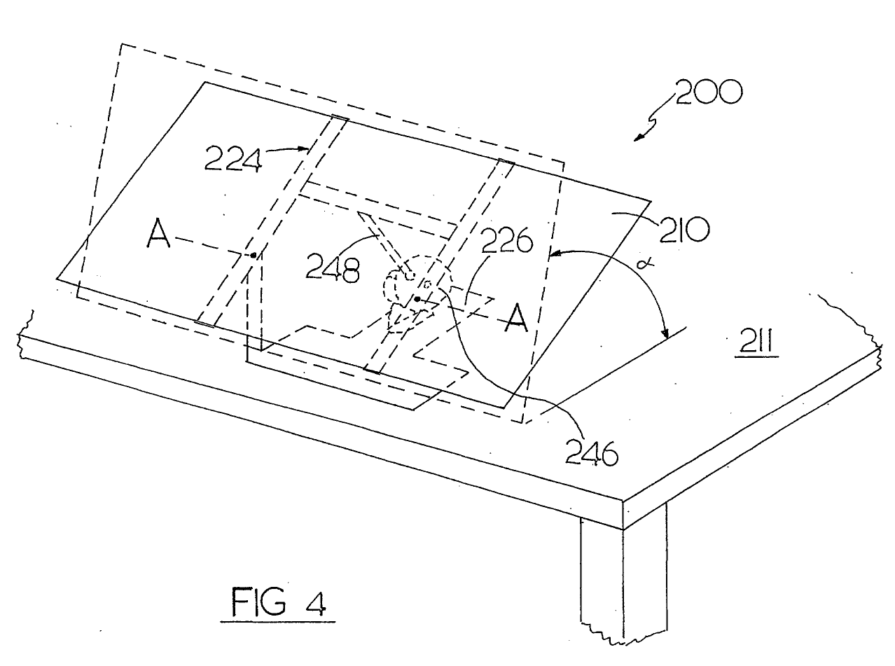

Since the lenses 16 are substantially horizontally disposed, and typically situated more than 2 metres above ground level, a viewer passing or approaching the apparatus 20 will, because of the change in their angle of vision as they pass, see more than one image even if the apparatus 20 is static in the display state which the apparatus 20 adopts at the time of approach. Further, a stationary viewer is exposed to more than one image as the apparatus 20 oscillates between display states. The operator is thus able to control the image viewed by the viewer and the dependency on the viewer to have to move past the lenticular image to see both images is removed. The apparatus 20 is particularly suitable for wide landscape advertising mounted more than 2 metres above ground level, and preferably in a horizontal plane. A horizontal orientation of the lenses 16 allows viewing from wide angles in addition to allowing increased dimensions, particularly in the length of the lenticular image 10. Such landscape (or substantially horizontally disposed) lenticular images 10 will benefit from the addition of lighting thereto, such as back or edge lighting. Suitable but not limiting dimensions for the lenticular image 10, in a horizontal plane, are 5 metres in width and 1 metre in height. Suitable but not limiting dimensions for a substantially vertically orientated lenticular image 10 would be 2 metres in height and 0.75 metres in width. For counter top units as illustrated in FIGS. 4-6, suitable but not limiting dimensions would be 1 metre in width and 0.5 metres in height.

It will be appreciated that the position of the pivot axis of the apparatus 20 i.e. as determined by the relative position of the lugs 36 and the support frame 24, is also a factor in defining the display states for a particular lenticular image. In an alternative embodiment (not shown), the relative position of the lugs (or equivalent member) and the retaining members (or equivalent member) is adjustable to further assist in setting up display states to suit a particular lenticular image. Also, the pivot axis is positioned depending on the height H (see FIG. 1) of the lenticular image 10 and on the movement required to ensure that both images can be clearly seen (this is dependent on the dimensions of the lenses 16).

Referring now to FIGS. 4 to 6, there is shown a lenticular image display apparatus 200 of the same general type described with reference to FIGS. 2 and 3, and similar numerals are used to indicate like parts.

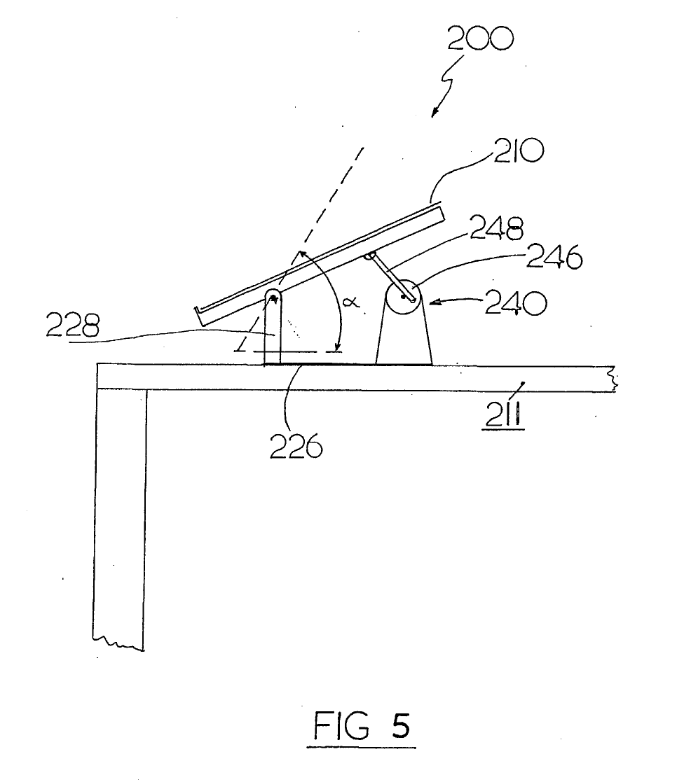

The apparatus 200 is particularly suited for use with counter tops, work benches or similar generally horizontally disposed surfaces. As shown in FIGS. 4 and 5, the backplate 226 (of substantially inverted “T”-shape) of the apparatus 200 rests, in use, on a surface such as a counter top 211. The apparatus 200 is operated in a similar manner to that described with reference to FIGS. 2 and 3 such that the lenticular image 210 is angularly displaced, back and forth, between two display states (one display state being shown in dashed outline in FIGS. 4 and 5). In comparison with the embodiment of FIGS. 2 and 3, the apparatus 200 is able to be angularly displaced to a greater extent (see angle α) of the support frame 224, and therefore the lenticular image 210, away from the backplate 226. To this end, the lever 248 and/or the disc 246 are dimensioned to give the motor and crank assembly 240 a further throw. It is preferred that, typically, the lenticular image 210 makes an angle α of between 25° and 75° with the surface 211 on which it rests as it is actuated between display states.

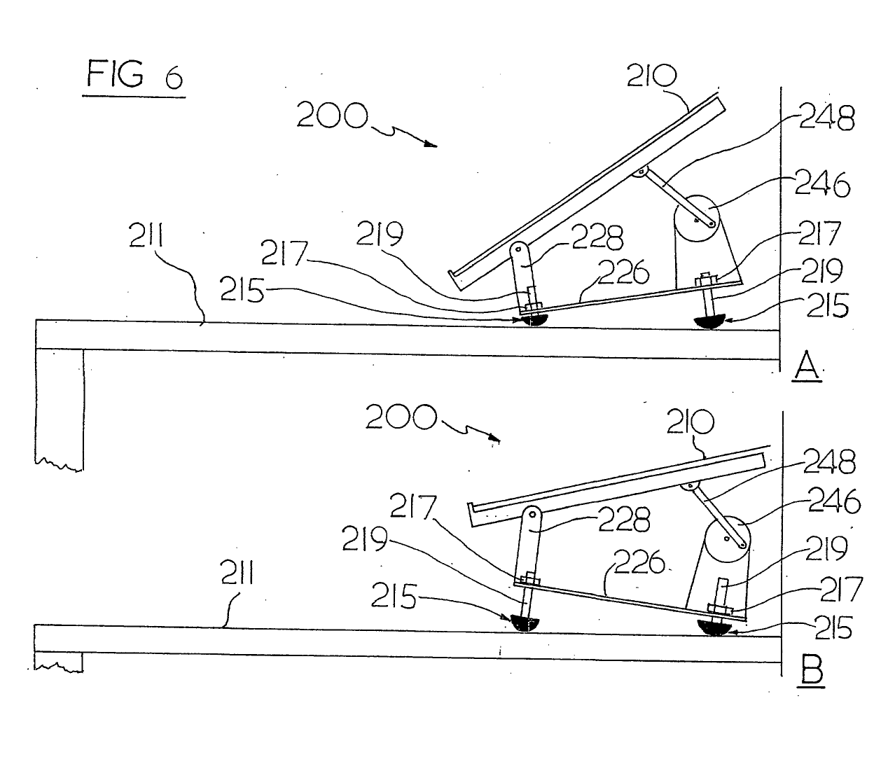

Referring now to FIGS. 6 a and b, the apparatus 200 optionally includes one or more stand members 215 for adjusting the distance of the backplate 226 from the surface 211 and tilting the apparatus 200 with respect to the surface. In FIG. 6, the apparatus 200 preferably comprises at least three stand members 215 (only two visible) adjustably connected to the backplate 226. If there are three stand members 215, they are triangularly spaced-apart and are screw-threaded to the backplate 226 via a respective nut 217 and bolt 219. Thus, the perpendicular distance to which each stand member 215 extends beneath the backplate 226 is adjustable, thereby allowing the backplate 226, and therefore the apparatus 200, to be displaced and tilted in a number of different ways with respect to the surface 211, as can be appreciated by a comparison of FIGS. 6a and 6b. It will be understood that there are a number of other conventional ways to provide similarly adjustable stand members.

The adjustable stand members 215 further facilitate the positioning of the display states thereby allowing the operator to create optimum display states for a given lenticular image.

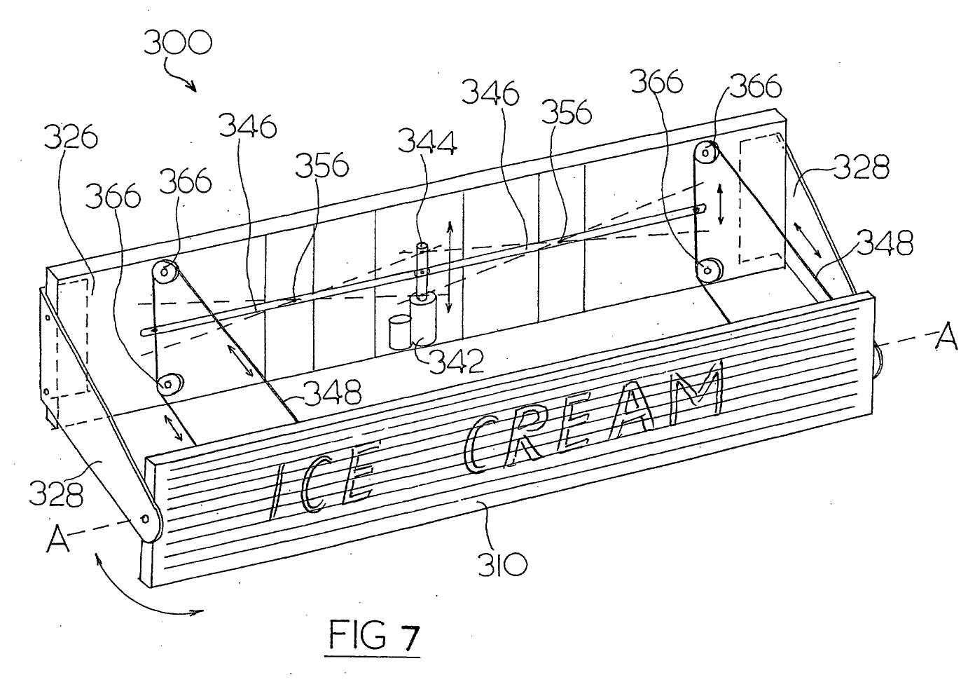

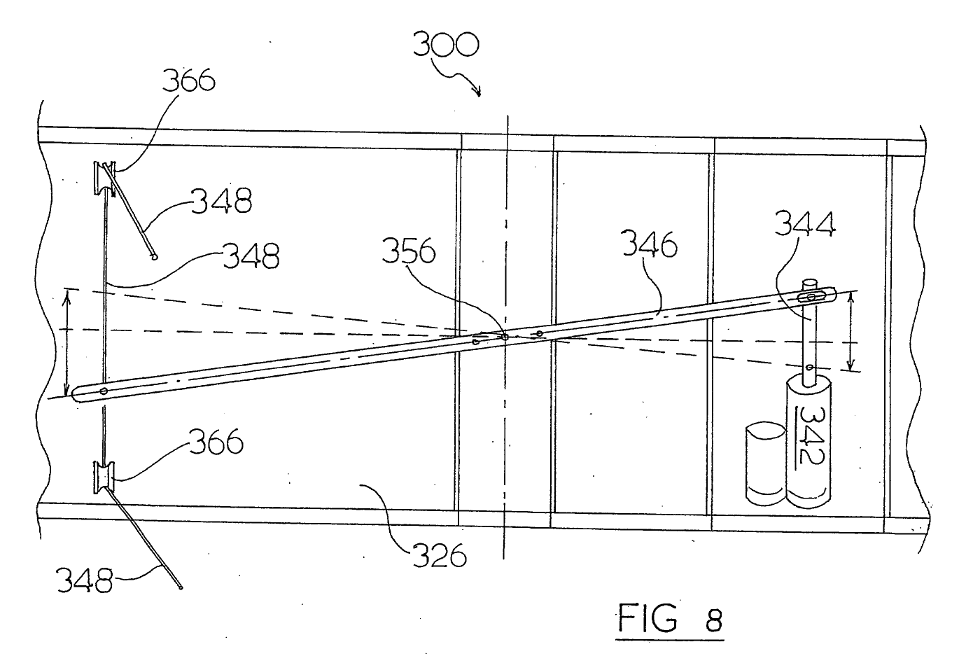

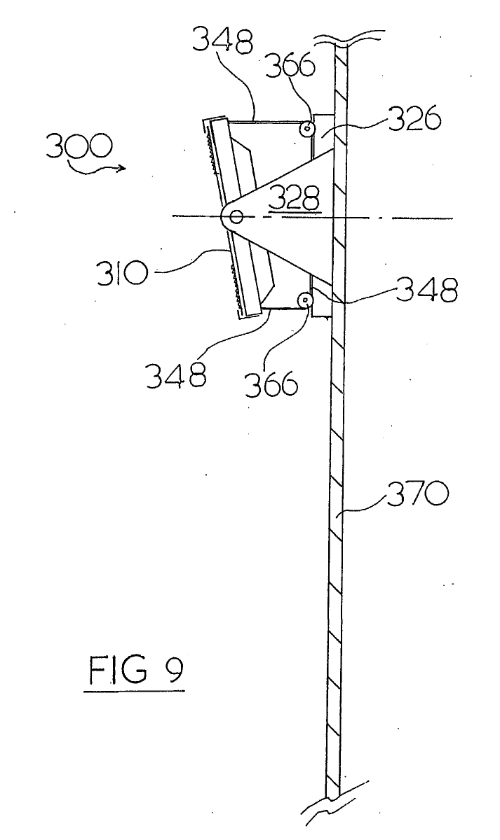

Referring now to FIGS. 7 to 9, there is illustrated an alternative embodiment of the invention of the same general type described with reference to FIGS. 2 and 3, indicated at 300, which utilises a lenticular image 310 identical in configuration to the lenticular image 10 as illustrated in FIG. 1. In the present embodiment, like components have been accorded similar reference numerals.

The lenticular image 310 is pivotally mounted to a back plate 326 via a pair of oppositely disposed arms 328 which support the lenticular image 310.

Mounted to the back plate 326 is a hydraulic cylinder 342 from which extends a hydraulic ram 344. The hydraulic ram 344 is conventionally operable to reciprocate within the hydraulic cylinder 342 using conventional control means (not shown). Pivotally connected to, and extending in opposite directions from the hydraulic ram 344 are a pair of lever members 346. The lever members 346 are pivotally mounted, proximal a respective centre point thereof, to the back plate 326 via lever pivots 356.

Secured to the respective opposed end of each of the lever members 346 is a belt 348 formed from any suitable material. Each belt 348 extends substantially perpendicularly, and in opposed directions, from the respective lever member 346, substantially parallel to the back plate 326. Each belt 348 passes over a pair of oppositely disposed pulleys 366, the pulleys 366 being mounted to the back plate 326. Each belt 348 passes through an angle of approximately 90° around each pulley 366, before extending outwardly thereof and connecting to the lenticular image 310.

In use, the hydraulic ram 344 is caused to reciprocate within the hydraulic cylinder 342, thereby effecting a reciprocating pivotal motion in each lever member 346 about each central pivot 356. The opposed free end of the lever member 346, to which the belt 348 is secured, is therefore imparted a like reciprocating motion, the magnitude of which may be altered by varying the position of the central pivot 356 on the lever member 346. It is therefore apparent that each belt 348 will undergo the same reciprocation and, being coupled to the pivotally mounted lenticular image 310, will impart a pivoting movement thereto about axis A-A. It is therefore apparent that the operation of the present embodiment of the invention is substantially identical to the embodiment hereinbefore described, with reference to FIGS. 2 and 3.

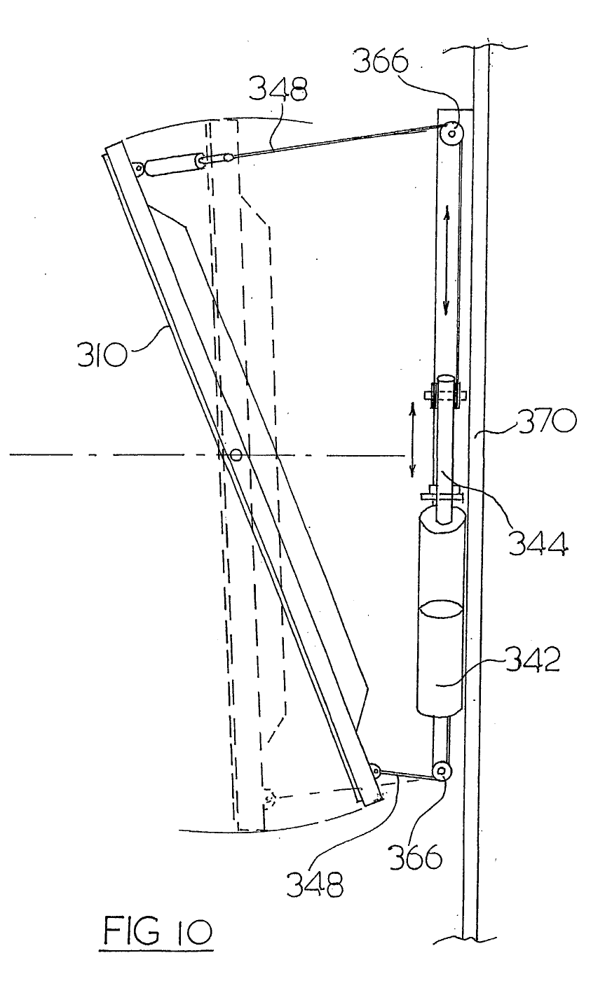

FIG. 10 is an equivalent illustration of the present embodiment of the invention to that of the apparatus 20 shown in FIG. 3 and operates in a like fashion.

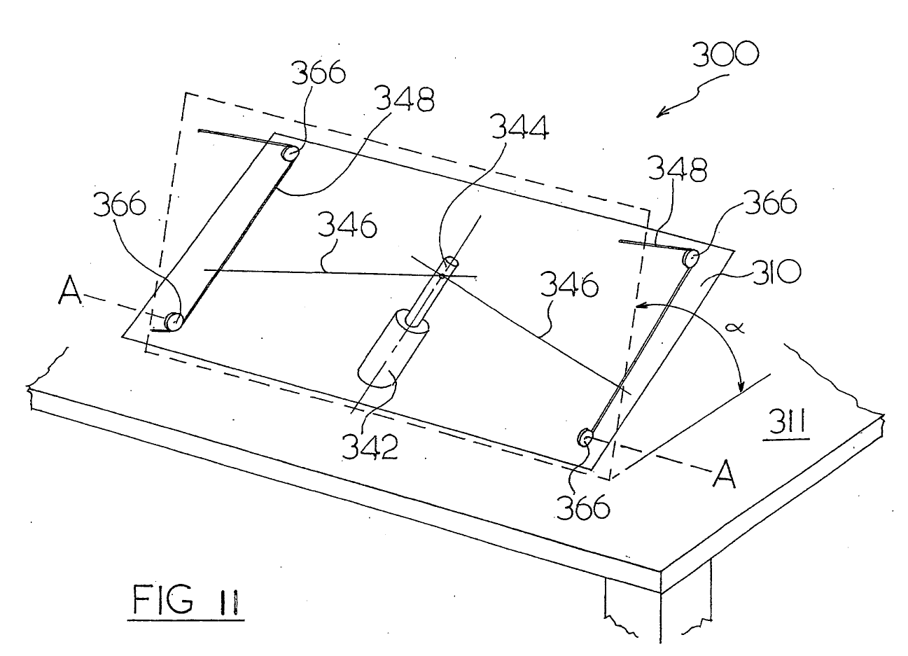

FIG. 11 is an equivalent illustration of the present embodiment of the invention to that of the apparatus 200 shown in FIG. 4.

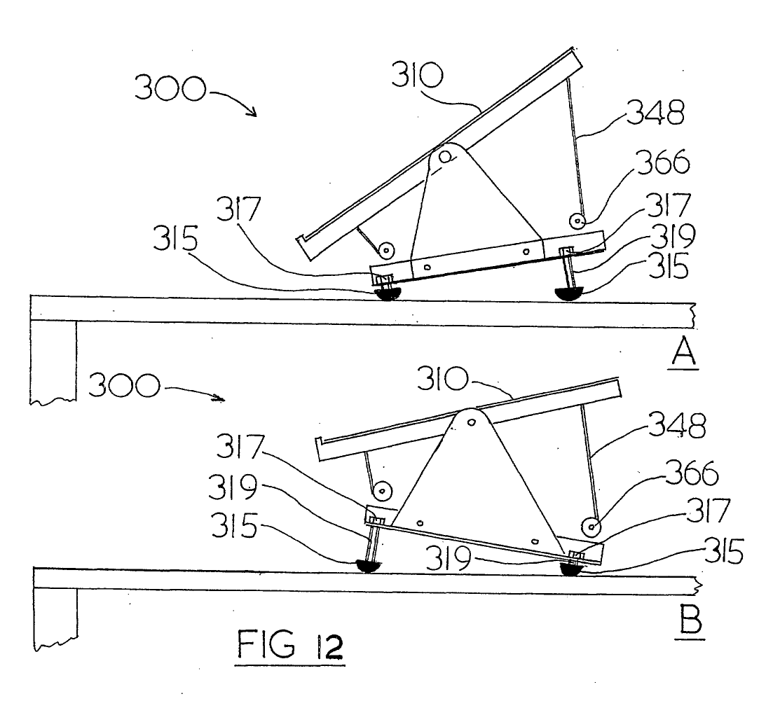

FIGS. 12a and 12b are equivalent illustrations of the present embodiment of the invention to that of the apparatus 200 shown in FIGS. 6a and 6b respectively, and the operation and applications are also equivalent.

As an alternative, the hydraulic cylinder 342 and hydraulic ram 344 may be replaced by an electric motor (not shown) having a cam (not shown) mounted thereon, with each lever member 346 having a corresponding follower (not shown) mounted adjacent the cam, the cam being shaped and dimensioned to impart a reciprocating motion to each of the followers, and therefore the lever members 346.

In another embodiment (not shown) the pivoting means may alternatively comprise a linear motor drive, or a conventional slow speed motor, electronically controlled to start and stop in pre-programmed positions and to provide predetermined dwell times in the display states. Such arrangements allow more display states to be adopted and under a more sophisticated control system.

Referring again to FIG. 1 particularly in the context of the apparatus 200, it is found that the optimum height H of the lenticular image for use with the apparatus 200 is between 150 mm and 300 mm. There are no limits to the width W.

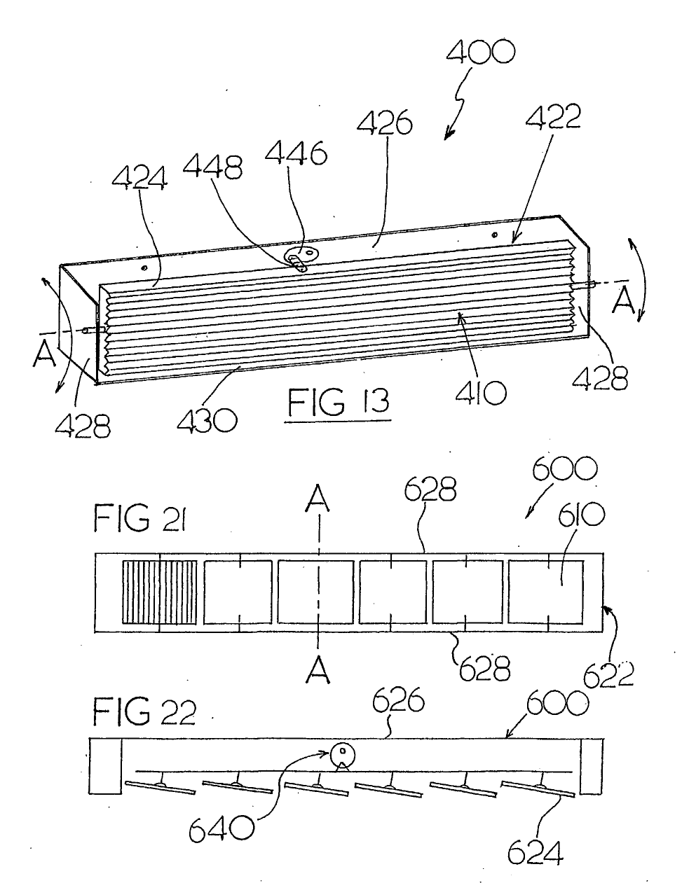

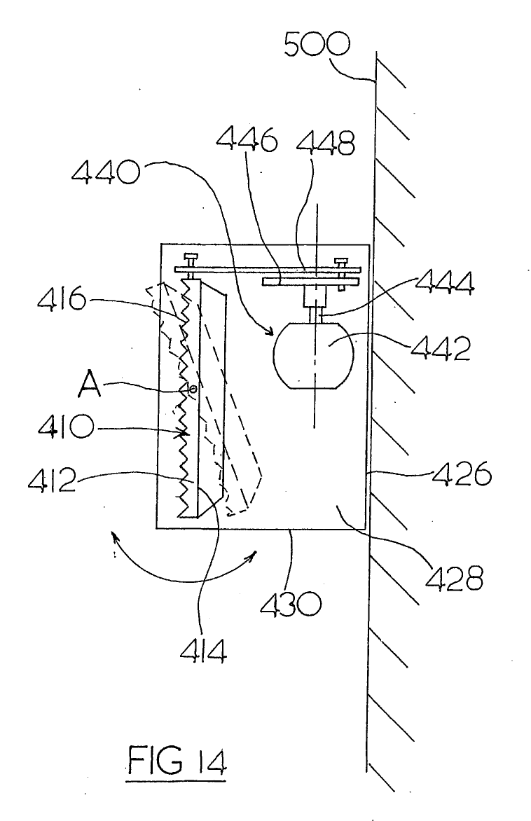

FIGS. 13 to 15 show a further embodiment of a display apparatus 400 according to the invention. In this embodiment, an elongated rectangular lenticular image 410 is fixedly mounted across the open front of a shallow support housing 424. The housing 424 is in turn mounted in a rectilinear support bracket or base member 422. The bracket 422 comprises a back plate 426, parallel side plates 428 extending forwardly from opposite ends of the back plate 426, and a base plate 430 extending forwardly from the bottom edge of the back plate 426 and joining the bottom edges of the side plates 428. The housing 424 is pivoted between the side plates 428 for rotation about an axis A-A parallel to the longitudinal axis of the image 410. In use of the apparatus 400, the back plate 426 is typically fixed to a vertical wall 500 (FIG. 14), with the pivot axis A-A substantially horizontal. However, the apparatus 400 is not restricted to that orientation in use.

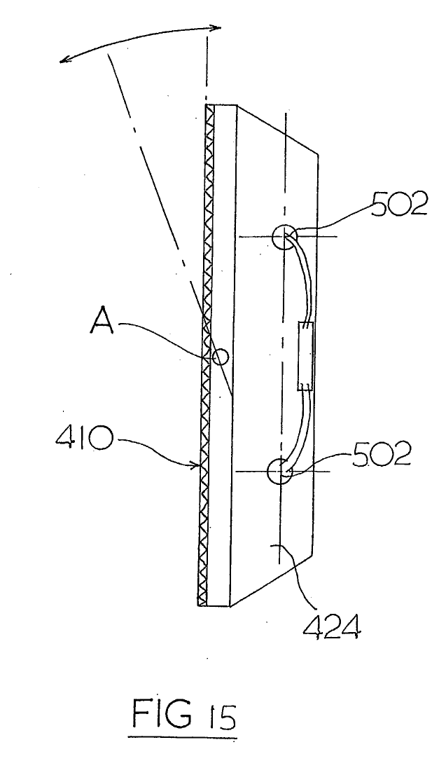

The lenticular image 410 comprises a sheet 412 of lenticular material having a plurality of substantially parallel lenses 416 which are, in this embodiment, triangular in cross-section and extend parallel to the pivot axis A-A. The image 410 also comprises an image-bearing substrate (not shown) attached to the flat rear surface 414 of the sheet 412. The image-bearing substrate comprises interleaved elemental image slices as previously described, the image slices being orientated parallel to the pivot axis A-A. The image slices may alternatively be printed directly onto the rear surface 414 of the sheet 412. The lenticular image 410 is preferably back-illuminated by a pair of fluorescent lamps 502 (see FIG. 15), contained within the housing 424 and extending along the length thereof parallel to the axis A-A.

The housing 424 is driven for reciprocating pivotal motion about the axis A-A by a motor and crank assembly 440 similar to the assembly 40 of FIGS. 2 and 3. The assembly 400 comprises an electric motor 442 mounted on the base plate 426 and which rotates a disk 446 mounted on a motor shaft 444. An arm 448 is coupled at one end to the top of the housing 424 and at the other end to the disk 446. The coupling of the arm 448 to the housing 424 is made via a lost motion connection (not shown) similar to the slide assembly 56, 58 of FIG. 3, and the coupling of the arm to the disk 446 is made via a selected pair of coupling elements (also not shown) similar to the elements 62, 66 of FIG. 3.

In use, the motor 442 is energised to slowly rotate the disk 446. This, via the arm 448, causes pivotal reciprocation of the housing 424, and hence of the image 410, about the axis A-A as indicated by the dashed lines in FIG. 14. Due to the lost motion connection between the arm 448 and housing 424 the housing will dwell (remain stationary) for a short period at each end of its range of angular motion.

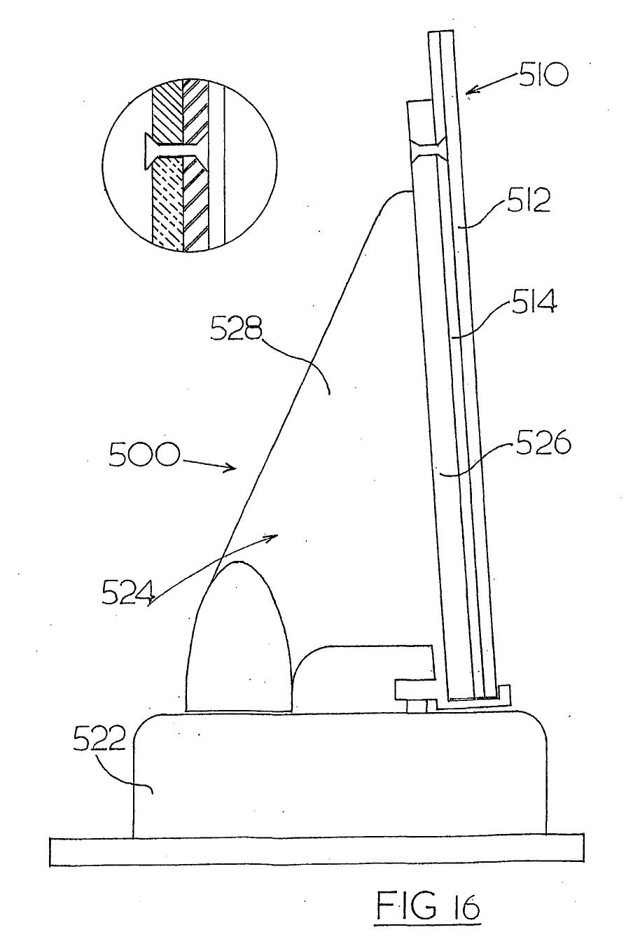

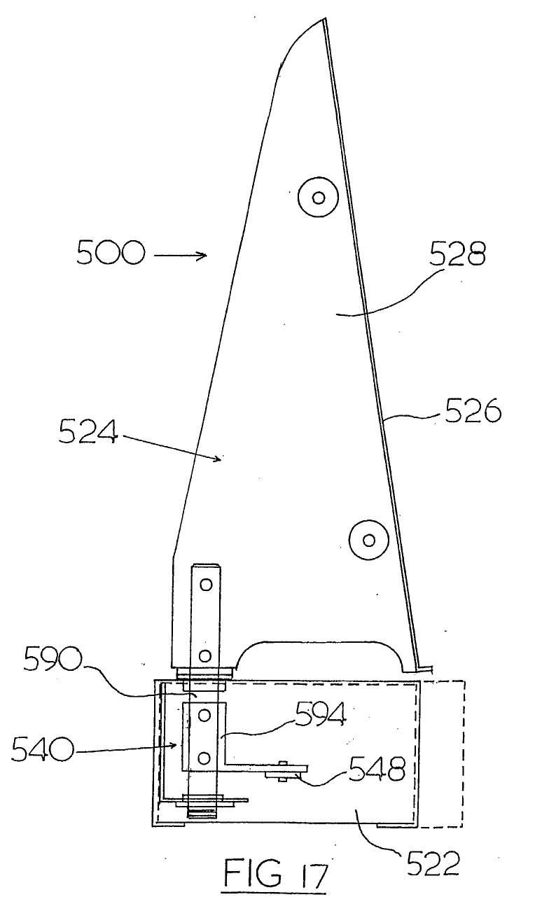

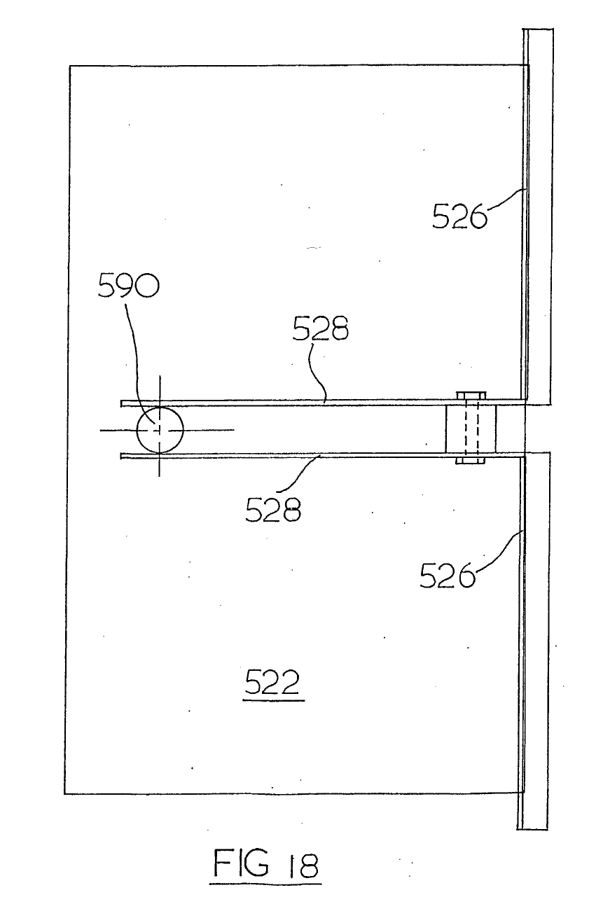

FIGS. 16 to 20 show a further embodiment of a display apparatus 500 according to the invention. In this embodiment, a lenticular image 510 is fixedly mounted (see insert to FIG. 16) to a substantially “T”-shaped support housing 524. The support housing 524 comprises a backplate 526 and a pair of mutually spaced-apart arms 528 extending rearwardly from the backplate 526. The support housing 524 is, in turn, mounted on a base member 522. The support housing 524 is pivoted for rotation about an axis A-A defined by a base shaft 590. In use of the apparatus 500, the base member 522 is typically located on a substantially horizontal surface.

The lenticular image 510 comprises a sheet 512 of lenticular material having a plurality of substantially parallel lenses (not shown) which extend parallel to the pivot axis A-A. The lenticular image 510 also comprises an image-bearing substrate 514 attached to the flat rear surface of the sheet 512. The image-bearing substrate 514 comprises interleaved elemental image slices as previously described, the image slices being oriented parallel to the pivot axis A-A.

The support housing 524 is driven for reciprocating pivotal movement about the axis A-A by a motor and crank assembly 540, similar to the assembly 40 of FIGS. 2 and 3. The assembly 540 comprises an electric motor 542 mounted on the base member 522 via a first L-shaped bracket 592 and which rotates a disk 546 mounted on a motor shaft 544. An arm 548 is coupled at one end to the base shaft 590 via a second L-shaped bracket 594, and at the other end to the disk 546. The coupling of the arm 548 to the base shaft 590 is made via a lost motion connection (not shown) similar to the slide assembly 56, 58 of FIG. 3, and the coupling of the arm 548 to the disk 446 is made via a selected pair of coupling elements (not shown) similar to the elements 62, 66 of FIG. 3.

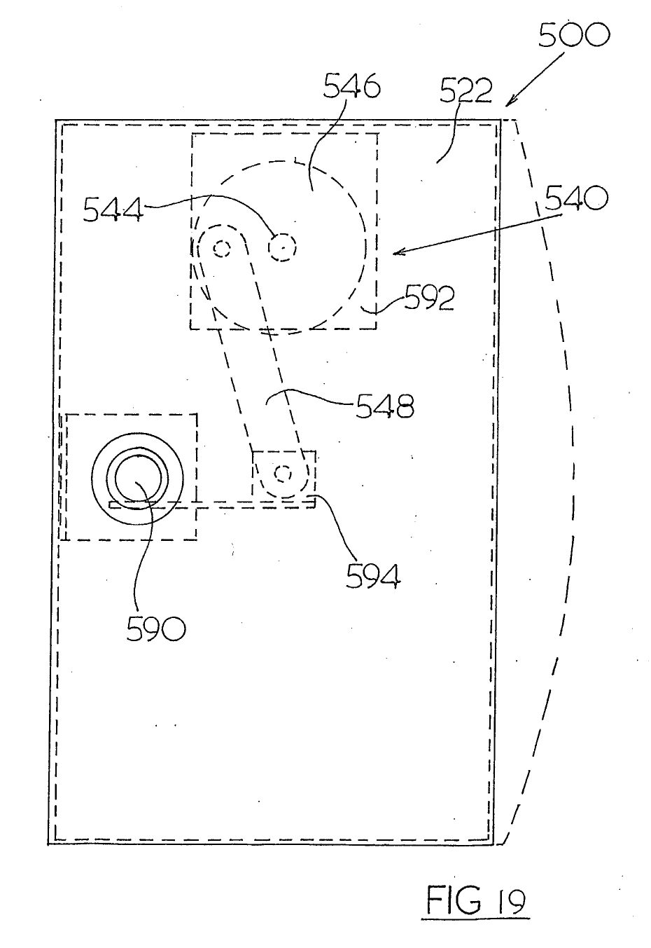

In use, the motor 542 is energised to slowly rotate the disk 546. This, via the arm 548, causes reciprocating pivotal movement of the base shaft 590, to which the arms 528 of the support housing 524 are mounted. This causes pivotal reciprocation of the support housing 524 about the base shaft 590 and, hence, causes angular displacement, in the present embodiment, arcuate displacement of the lenticular image 510, about the axis A-A, indicated as dashed lines in FIG. 20. Due to the lost motion connection between the base member 522 and the base shaft 590, the support housing 524 will dwell (or remain stationary) for a short period at each end of its range of angular motion.

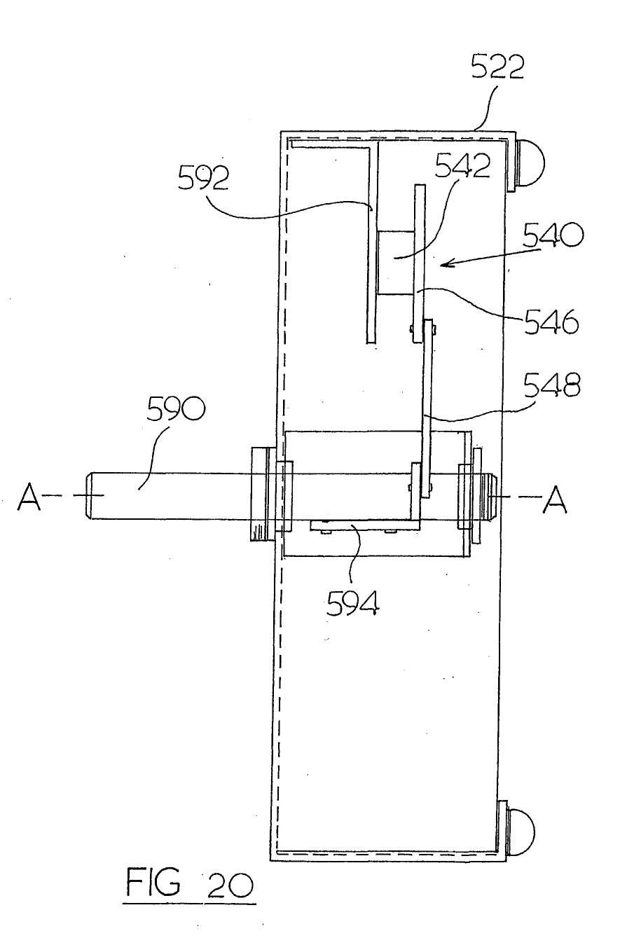

FIGS. 21 and 22 show a further embodiment of a display apparatus 600 according to the invention. In this embodiment, six lenticular images 610 are arranged, in series, and each are fixedly mounted across the open front of a respective shallow support housing 624, similar to the support housing 424 of FIGS. 13 to 15. The support housings 624 are, in turn, mounted in a base member 622 and the support housings 624 are pivoted between side plates 628, for rotation about an axis A-A as indicated by dashed lines in FIG. 21. In use, a backplate 626 of the base member 622 is typically fixed to a vertical wall, with the pivot axis A-A substantially vertical. However, the apparatus 600 is not restricted to that orientation in use.

The six lenticular images 610, in series, are coupled for pivotable rotation about six axes A-A, parallel to the longitudinal axes of the images 610.

The housing 624 is driven by a motor and crank assembly 640—any of the motor assemblies already described are suitable for use in the present embodiment.

In the embodiment of FIGS. 21 and 22, the lenticular images 610 may be arranged substantially horizontally or substantially vertically. In addition, the motor assembly 640 may be coupled (not shown) to the individual lenticular images 610, so that the individual lenticular images 610 are angularly displaced, in unison, or in turn, the latter achieving a “Mexican wave” type effect. Arcuate displacement of the lenticular image 10, 110, 210, 210, 410, 510, 610 is preferred. This can be achieved by ensuring that the pivot axis A-A is spaced-apart from the plane of the, or each lenticular image, as is illustrated in the fifth embodiment above.

I claim:

1. An orientation-sensitive image display apparatus comprising a base member; a support member for carrying at least one orientation-sensitive image, the support member being pivotably coupled to the base member; and a displacing mechanism for angularly displacing the support member relative to the base member about a pivot axis, wherein said at least one orientation-sensitive image includes a plurality of lenses, the orientation-sensitive image being carried, in use, on the support member so that the lenses are substantially parallelly disposed with respect to said pivot axis.

2. A display apparatus according to claim 1, in which the base member is mounted, in use, on a surface so that the lenses of the orientation-sensitive image are substantially horizontally disposed.

3. A display apparatus according to claim 1, in which the displacing mechanism is arranged to displace the support member between a plurality of angularly displaced display states.

4. A display apparatus according to claim 3, in which the displacing mechanism is arranged to maintain the support member in each display state for a predetermined period of time.

5. A display apparatus according to claim 3, in which the displacing mechanism includes an angular displacement adjustment mechanism for adjusting the angular displacement between adjacent display states.

6. A display apparatus according to claim 3, in which the displacing mechanism includes an angular position adjusting mechanism for adjusting the angular position of the support member in a display state with respect to the base member.

7. A display apparatus according to claim 1 in which the displacing mechanism comprises an actuator coupled to a lever member on one side thereof and adapted to effect, in use, reciprocating motion of the opposed side of the lever member, the opposed side of the lever member being coupled to the support member such as to effect reciprocating motion thereof.

8. A display apparatus according to claim 7, in which the lever member is coupled to the support member by means of a belt and pulley system.

9. A display apparatus according to claim 7, in which the actuator comprise a hydraulic or pneumatic ram.

10. A display apparatus according to claim 7, in which the actuator comprises a motor and cam assembly.

11. A display apparatus according to claim 1, in which the displacing mechanism comprises a motor and crank assembly coupled between the base member and the support member, the crank assembly comprising a rotatable member coupled to the motor shaft for rotation therewith and a lever member coupled to the rotatable member.

12. A display apparatus according to claim 6, in which the angular position adjustment mechanism comprises a plurality of first coupling members spaced-apart along the longitudinal axis of the lever member, and at least one co-operating coupling member provided on the rotatable member for coupling to a selected one of said first coupling members.

13. A display apparatus according to claim 5, in which the angular displacement adjustment mechanism comprises a plurality of radially spaced-apart second coupling members provided on the rotatable member, and at least one co-operating coupling member provided in the lever member for coupling to a selected one of said second coupling members.

14. A display apparatus according to claim 4, in which the displacing mechanism comprises a slide assembly provided on the lever member, the slide assembly comprising a male member slidably received in an elongate female member, the arrangement being such that rotation of the rotatable member causes the male member to slide along the female member and pivotable movement of the support member is effected when the male member engages with either end of the female member.

15. A display apparatus according to claim 11, in which the motor is provided on the base member and the lever member is coupled to the support member.

16. A display apparatus according to claim 1, in which the orientation-sensitive image is arcuately displaced, relative to the base member.

17. A display apparatus according to claim 1, in which the orientation-sensitive image is pivotably displaced, relative to the base member.

18. A display apparatus according to claim 1, in which the displacing mechanism is arranged to effect reciprocating pivotal movement of the support member.

19. A display apparatus according to claim 1, in which the orientation-sensitive image comprises a lenticular image.

20. A display apparatus according to claim 1, in which the orientation-sensitive image comprises a hologram.

21. A display apparatus according to claim 1, in which the support member is adapted to carry a plurality of orientation-sensitive images.
